(19) United States
(12) Patent Application Publication
(10) Pub. No.: US 2022/0286737 A1
(43) Pub. Date: Sep. 8, 2022

(54) Separating Media Content into Program Segments and Advertisement Segments

(71) Applicant: Gracenote, Inc., Emeryville, CA (US)

(72) Inventors: Todd J. Hodges, Oakland, CA (US); Andreas Schmidt, San Pablo, CA (US); Sharmishtha Gupta, Fremont, CA (US)

(21) Appl. No.: 17/496,297

(22) Filed: Oct. 7, 2021

Related U.S. Application Data
(60) Provisional application No. 63/157,288, filed on Mar. 5, 2021.

(51) Int. Cl. H04N 21/44; H04N 21/81

(52) U.S. Cl. CPC H04N 21/44008; H04N 21/812

(57) ABSTRACT

In one aspect, an example method includes (i) extracting, by a computing system, features from media content; (ii) generating, by the computing system, repetition data for respective portions of the media content using the features, with repetition data for a given portion including a list of other portions of the media content matching the given portion; (iii) determining, by the computing system, transition data for the media content; (iv) selecting, by the computing system, a portion within the media content using the transition data; (v) classifying, by the computing system, the portion as either an advertisement segment or a program segment using repetition data for the portion; and (vi) outputting, by the computing system, data indicating a result of the classifying for the portion.

### CROSS-REFERENCE TO RELATED APPLICATIONS

This disclosure claims priority to U.S. Provisional Patent App. No. 63/157,288 filed on Mar. 5, 2021, which is hereby incorporated by reference in its entirety.

### USAGE AND TERMINOLOGY

In this disclosure, unless otherwise specified and/or unless the particular context clearly dictates otherwise, the terms “a” or “an” mean at least one, and the term “the” means the at least one.

In this disclosure, the term “connection mechanism” means a mechanism that facilitates communication between two or more components, devices, systems, or other entities. A connection mechanism can be a relatively simple mechanism, such as a cable or system bus, or a relatively complex mechanism, such as a packet-based communication network (e.g., the Internet). In some instances, a connection mechanism can include a non-tangible medium (e.g., in the case where the connection is wireless).

In this disclosure, the term “computing system” means a system that includes at least one computing device. In some instances, a computing system can include one or more other computing systems.

### BACKGROUND

In various scenarios, a content distribution system can transmit content to a content presentation device, which can receive and output the content for presentation to an end-user. Further, such a content distribution system can transmit content in various ways and in various forms. For instance, a content distribution system can transmit content in the form of an analog or digital broadcast stream representing the content.

In an example configuration, a content distribution system can transmit content on one or more discrete channels (sometimes referred to as stations or feeds). A given channel can include content arranged as a linear sequence of content segments, including, for example, program segments and advertisement segments.

Closed captioning (CC) is a video-related service that was developed for the hearing-impaired. When CC is enabled, video and text representing an audio portion of the video are displayed as the video is played. The text may represent, for example, spoken dialog or sound effects of the video, thereby helping a viewer to comprehend what is being presented in the video. CC may also be disabled such that the video may be displayed without such text as the video is played. In some instances, CC may be enabled or disabled while a video is being played.

CC may be generated in a variety of manners. For example, an individual may listen to an audio portion of video and manually type out corresponding text. As another example, a computer-based automatic speech-recognition system may convert spoken dialog from video to text.

Once generated, CC may be encoded and stored in the form of CC data. CC data may be embedded in or otherwise associated with the corresponding video. For example, for video that is broadcast in an analog format according to the National Television Systems Committee (NTSC) standard, the CC data may be stored in line twenty-one of the vertical blanking interval of the video, which is a portion of the television picture that resides just above a visible portion. Storing CC data in this manner involves demarcating the CC data into multiple portions (referred to herein as “CC blocks”) such that each CC block may be embedded in a correlating frame of the video based on a common processing time. In one example, a CC block represents two characters of text. However a CC block may represent more or less characters.

For video that is broadcast in a digital format according to the Advanced Television Systems Committee (ATSC) standard, the CC data may be stored as a data stream that is associated with the video. Similar to the example above, the CC data may be demarcated into multiple CC blocks, with each CC block having a correlating frame of the video based on a common processing time. Such correlations may be defined in the data stream. Notably, other techniques for storing video and/or associated CC data are also possible.

A receiver (e.g., a television) may receive and display video. If the video is encoded, the receiver may receive, decode, and then display each frame of the video. Further, the receiver may receive and display CC data. In particular, the receiver may receive, decode, and display each CC block of CC data. Typically, the receiver displays each frame and a respective correlating CC block as described above at or about the same time.

### SUMMARY

In one aspect, an example method is disclosed. The method includes (i) extracting, by a computing system, features from media content; (ii) generating, by the computing system, repetition data for respective portions of the media content using the features, with repetition data for a given portion including a list of other portions of the media content matching the given portion; (iii) determining, by the computing system, transition data for the media content; (iv) selecting, by the computing system, a portion within the media content using the transition data; (v) classifying, by the computing system, the portion as either an advertisement segment or a program segment using repetition data for the portion; and (vi) outputting, by the computing system, data indicating a result of the classifying for the portion.

In another aspect, an example non-transitory computer-readable medium is disclosed. The non-transitory computer-readable medium has stored thereon program instructions that upon execution by a processor, cause performance of a set of acts including (i) extracting features from media content; (ii) generating repetition data for respective portions of the media content using the features, with repetition data for a given portion including a list of other portions of the media content matching the given portion; (iii) determining transition data for the media content; (iv) selecting a portion within the media content using the transition data; (v) classifying the portion as either an advertisement segment or a program segment using repetition data for the portion; and (vi) outputting data indicating a result of the classifying for the portion.

In another aspect, an example computing system is disclosed. The computing system is configured for performing a set of acts including (i) extracting features from media content; (ii) generating repetition data for respective portions of the media content using the features, with repetition data for a given portion including a list of other portions of the media content matching the given portion; (iii) determining transition data for the media content; (iv) selecting a portion within the media content using the transition data; (v) classifying the portion as either an advertisement segment or a program segment using repetition data for the portion; and (vi) outputting data indicating a result of the classifying for the portion.

### BRIEF DESCRIPTION OF THE DRAWINGS

FIG. 1 is a simplified block diagram of an example computing device.

FIG. 2 is a simplified block diagram of an example computing system in which various described principles can be implemented.

FIG. 3 is a simplified block diagram of an example feature extraction module.

FIG. 4 is a simplified block diagram of an example repetitive content detection module.

FIG. 5 is a simplified block diagram of an example segment processing module.

FIG. 6 is a flow chart of an example method.

### DETAILED DESCRIPTION

### I. Overview

In the context of an advertisement system, it can be useful to know when and where advertisements are inserted. For instance, it may be useful to understand which channel(s) an advertisement airs on, the dates and times that the advertisement aired on that channel, etc. Further, it may also be beneficial to be able to obtain copies of advertisements that are included within a linear sequence of content segments. For instance, a user of the advertisement system may wish to review the copies to confirm that an advertisement was presented as intended (e.g., to confirm that an advertisement was presented in its entirety to the last frame). In addition, for purposes of implementing an audio and/or video fingerprinting system, it may be desirable to have accurate copies of advertisements that can be used to generate reference fingerprints.

Still further, in some instances, when media content, such as a television show, is provided with advertisements that are inserted between program segments, it may be useful to obtain a copy of the television show from which the advertisements have been removed. This can allow a fingerprinting system to more granularly track and identify a location in time within the television show when a fingerprint of the television show is obtained from the television show during a scenario in which the television show is being presented without advertisements. The television show might not include advertisements, for instance, when the television show is presented via an on-demand streaming service at a later time than a time at which the television was initially broadcast or streamed.

Disclosed herein are methods and systems for separating media content into program segments and advertisement segments. In an example method, a computing system can extract features from media content, and generate repetition data for respective portions of the media content using the features. The repetition data for a given portion includes a list of other portions of the media content matching the given portion. In addition, the computing system can determine transition data for the media content, and select a portion within the media content using the transition data. The computing system can then classify the portion as either an advertisement segment or a program segment using repetition data for the portion. And the computing system can output data indicating a result of the classifying for the portion.

Various other features of the example method discussed above, as well as other methods and systems, are described hereinafter with reference to the accompanying figures.

### II. Example Architecture

A. Computing Device

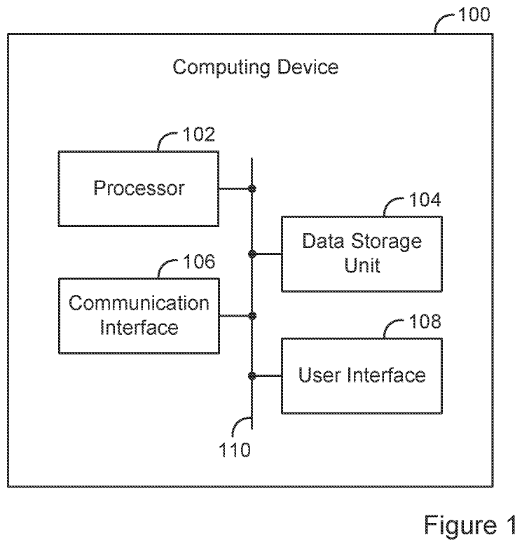

FIG. 1 is a simplified block diagram of an example computing device 100. Computing device 100 can perform various acts and/or functions, such as those described in this disclosure. Computing device 100 can include various components, such as processor 102, data storage unit 104, communication interface 106, and/or user interface 108. These components can be connected to each other (or to another device, system, or other entity) via connection mechanism 110.

Processor 102 can include a general-purpose processor (e.g., a microprocessor) and/or a special-purpose processor (e.g., a digital signal processor (DSP)).

Data storage unit 104 can include one or more volatile, non-volatile, removable, and/or non-removable storage components, such as magnetic, optical, or flash storage, and/or can be integrated in whole or in part with processor 102. Further, data storage unit 104 can take the form of a non-transitory computer-readable storage medium, having stored thereon program instructions (e.g., compiled or non-compiled program logic and/or machine code) that, when executed by processor 102, cause computing device 100 to perform one or more acts and/or functions, such as those described in this disclosure. As such, computing device 100 can be configured to perform one or more acts and/or functions, such as those described in this disclosure. Such program instructions can define and/or be part of a discrete software application. In some instances, computing device 100 can execute program instructions in response to receiving an input, such as from communication interface 106 and/or user interface 108. Data storage unit 104 can also store other types of data, such as those types described in this disclosure.

Communication interface 106 can allow computing device 100 to connect to and/or communicate with another entity according to one or more protocols. In one example, communication interface 106 can be a wired interface, such as an Ethernet interface or a high-definition serial-digital-interface (HD-SDI). In another example, communication interface 106 can be a wireless interface, such as a cellular or WI-FI interface. In this disclosure, a connection can be a direct connection or an indirect connection, the latter being a connection that passes through and/or traverses one or more entities, such as a router, switcher, or other network device. Likewise, in this disclosure, a transmission can be a direct transmission or an indirect transmission.

User interface 108 can facilitate interaction between computing device 100 and a user of computing device 100, if applicable. As such, user interface 108 can include input components such as a keyboard, a keypad, a mouse, a touch-sensitive panel, a microphone, and/or a camera, and/or output components such as a display device (which, for example, can be combined with a touch-sensitive panel), a sound speaker, and/or a haptic feedback system. More generally, user interface 108 can include hardware and/or software components that facilitate interaction between computing device 100 and the user of the computing device 100.

B. Example Computing Systems

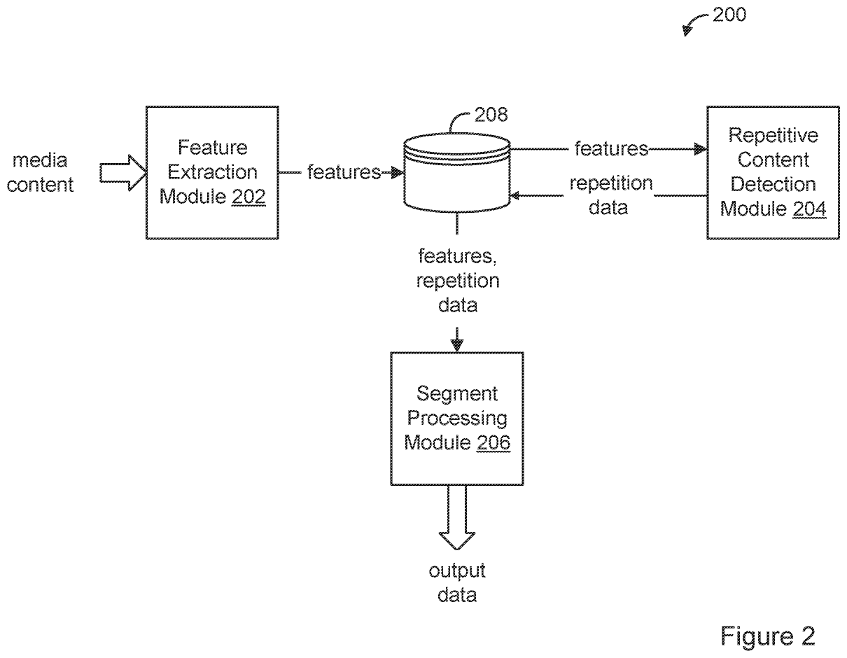

FIG. 2 is a simplified block diagram of an example computing system 200. Computing system 200 can perform various acts and/or functions, such as those related to separating media content into program content and advertisement content as described herein.

As shown in FIG. 2, computing system 200 includes a feature extraction module 202, a repetitive content detection module 204, and a segment processing module 206. Each of feature extraction module 202, repetitive content detection module 204, and segment processing module 206 can be implemented using hardware (e.g., a processor of a machine, a field-programmable gate array (FPGA), or an application-specific integrated circuit (ASIC)), or a combination of hardware and software. Moreover, any two or more of the components depicted in FIG. 2 can be combined into a single component, and the functions described herein for a single component can be subdivided among multiple components.

Computing system 200 can be configured to receive media content as input, analyze the media content using feature extraction module 202, repetitive content detection module 204, and segment processing module 206, and output data based on a result of the analysis. In one example, the media content can include a linear sequence of content segments transmitted on one or more discrete channels (sometimes referred to as stations or feeds). For instance, the media content can be a record of media content transmitted on one or more discrete channels during a portion of a day, an entire day, or multiple days. As such, media content can include program segments (e.g., shows, sporting events, movies) and advertisement segments (e.g., commercials). In some examples, media content can include video content, such as an analog or digital broadcast stream transmitted by one or more television stations and/or web services. In other examples, media content can include audio content, such as a broadcast stream transmitted by one or more radio stations and/or web services.

Feature extraction module 202 can be configured to extract one or more features from the media content, and store the features in a database 208. Repetitive content detection module 204 can be configured to generate repetition data for respective portions of the media content using the features, and store the repetition data in database 208. Further, segment processing module 206 can be configured to classify at least one portion of the media content as either an advertisement segment or a program segment using the repetition data for the at least one portion, and output data indicating a result of the classifying for the at least one portion.

The output data can take various forms. As one example, the output data can include a text file that identifies the at least one portion (e.g., a starting timestamp and an ending timestamp of the portion within the media content) and a classification for the at least one portion (e.g., advertisement segment or program segment). For instance, the output data for portion that is classified as a program segment can include a data file for a program specified in an electronic program guide (EPG). The data file for the program can include indications of one or more portions corresponding to the program. The output data for a portion that is classified as an advertisement segment can include an indication of the portion as well as metadata for the portion. The output data can be stored in database 208, and/or output to another computing system or device.

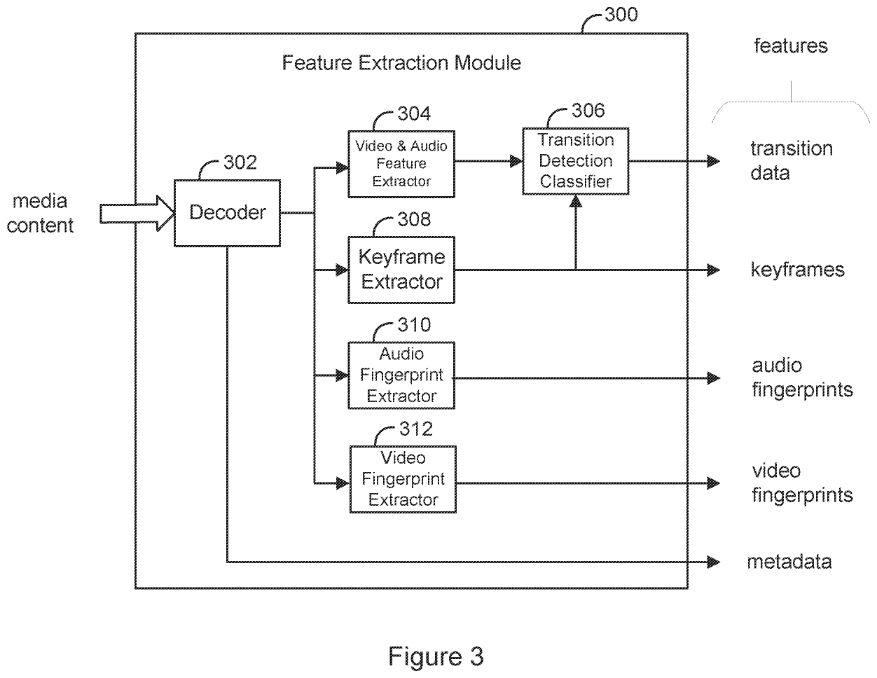

FIG. 3 is a simplified block diagram of an example feature extraction module 300. Feature extraction module 300 can perform various acts and/or functions related to extracting features from media content. For instance, feature extraction module 300 is an example configuration of feature extraction module 202 of FIG. 2.

As shown in FIG. 3, feature extraction module 300 can include a decoder 302, a video and audio feature extractor 304, a transition detection classifier 306, a keyframe extractor 308, an audio fingerprint extractor 310, and a video fingerprint extractor 312. Each of decoder 302, video and audio feature extractor 304, transition detection classifier 306, keyframe extractor 308, audio fingerprint extractor 310, and video fingerprint extractor 312 can be implemented as a computing system. For instance, one or more of the components depicted in FIG. 3 can be implemented using hardware (e.g., a processor of a machine, a field-programmable gate array (FPGA), or an application-specific integrated circuit (ASIC)), or a combination of hardware and software. Moreover, any two or more of the components depicted in FIG. 3 can be combined into a single component, and the function described herein for a single component can be subdivided among multiple components.

Decoder 302 can be configured to convert the received media content into a format(s) that is usable by video and audio feature extractor 304, keyframe extractor 308, audio fingerprint extractor 310, and video fingerprint extractor 312. For instance, decoder 302 can convert the received media content into a desired format (e.g., MPEG-4 Part 14 (MP4)). In some instances, decoder 302 can be configured to separate raw video into video data, audio data, and metadata. The metadata can include timestamps, reference identifiers (e.g., Tribune Media Services (TMS) identifiers), a language identifier, and closed captioning (CC), for instance.

In some examples, decoder 302 can be configured to downscale video data and/or audio data. This can help to speed up processing.

In some examples, decoder 302 can be configured to determine reference identifiers for portions of the media content. For instance, decoder 302 can determine TMS IDs for portions of the media content by retrieving the TMS IDs from a channel lineup for a geographic area that specifies the TMS ID of different programs that are presented on different channels at different times.

Video and audio feature extractor 304 can be configured to extract video and/or audio features for use by transition detection classifier 306. The video features can include a sequence of frames. Additionally or alternatively, the video features can include a sequence of features derived from frames or groups of frames, such as color palette features, color range features, contrast range features, luminance features, motion over time features, and/or text features (specifying an amount of text present in a frame). The audio features can include noise floor features, time domain features, or frequency range features, among other possible features. For instance, the audio features can include a sequence of spectrograms (e.g., mel-spectrograms and/or constant-Q transform spectrograms), chromagrams, and/or mel-frequency cepstrum coefficients (MFCCs).

In one example implementation, video and audio feature extractor 304 can be configured to extract features from overlapping portions of media content using a sliding window approach. For instance, a fixed-length window (e.g., a ten-second window, a twenty-second window, or a thirty-second window) can be slid over a sequence of media content to isolate fixed-length portions of the sequence of media content. For each isolated portion, video and audio feature extractor 304 can extract video features and audio features from the portion.

Transition detection classifier 306 can be configured to receive video and/or audio features as input, and output transition data. The transition data can be indicative of the locations of transitions between different content segments.

In an example implementation, transition detection classifier 306 can include a transition detector neural network and an analysis module. The transition detector neural network can be configured to receive audio features and video features for a portion of media content as input, process the audio features and video features to determine classification data. The analysis module can be configured to determine transition data based on classification data output by the transition detector neural network

In some examples, the classification data output by the transition detector neural network can include data indicative of whether or not the audio features and video features for the portion include a transition between different content segments. For example, the classification data can include a binary indication or probability of whether the portion includes a transition between different content segments. In some instances, the classification data can include data about a location of a predicted transition within the portion. For example, the transition detector neural network can be configured to perform a many-to-many-sequence classification and output, for each frame of the audio features and video features, a binary indication or a probability indicative of whether or not the frame includes a transition between different content segments.

Further, in some examples, the transition detector neural network can be configured to predict a type of transition. For instance, the classification data can include data indicative of whether or not the audio features and video features for a portion include a transition from a program segment to an advertisement segment, an advertisement segment to a program segment, an advertisement segment to another advertisement segment, and/or a program segment to another program segment. As one example, for each of multiple types of transitions, the transition data can include a binary indication or probability of whether the portion includes the respective type of transition. In line with the discussion above, in an implementation in which the transition detector neural network is configured to perform a many-to-many sequence classification, for each frame, the transition detector neural network can output, for each of multiple types of transitions, a binary indication or probability indicative of whether or not the frame includes the respective type of transition.

The configuration and structure of the transition detector neural network can vary depending on the desired implementation. As one example, the transition detector neural network can include a recurrent neural network. For instance, the transition detector neural network can include a recurrent neural network having a sequence processing model, such as stacked bidirectional long short-term memory (LSTM). As another example, the transition detector neural network can include a seq2seq model having a transformer-based architecture (e.g., a Bidirectional Encoder Representations from Transformers (BERT)).

In an example implementation, the transition detector neural network can include a recurrent neural network having audio feature extraction layers, video feature extraction layers, and classification layers. The audio feature extraction layers can include one or more convolution layers and be configured to receive as input a sequence of audio features (e.g., audio spectrograms) and output computation results. The computation results are a function of weights of the convolution layers, which can be learned during training. The video feature extraction layers can similarly include one or more convolution layers and be configured to receive as input a sequence of video features (e.g., video frames) and to output computation results. Computation results from the audio feature extraction layers and computation results from the video feature extraction layers can then be concatenated together, and provided to the classification layers. The classification layers can receive concatenated features for a sequence of frames, and output, for each frame, a probability indicative of whether the frame is transition between different content segments. The classification layers can include bidirectional LSTM layers and fully convolutional neural network (FCN) layers. The probabilities determined by the classification layers are a function of hidden weights of the FCN layers, which can be learned during training.

In some examples, the transition detector neural network can be configured to receive as input additional features extracted from a portion of media content. For instance, the transition detector neural network can be configured to receive: closed captioning features representing spoken dialog or sound effects; channel or station identifiers features representing a channel on which the portion was transmitted; programming features representing a title, genre, day of week, or time of day; blackframe features representing the locations of blackframes; and/or keyframe features representing the locations of keyframes.

Video content can include a number of shots. A shot of video content includes consecutive frames which show a continuous progression of video and which are thus interrelated. In addition, video content can include solid color frames that are substantially black, referred to as blackframes. A video editor can insert blackframes between shots of a video, or even within shots of a video. Additionally or alternatively, blackframes can be inserted between program segments and advertisement segments, between different program segments, or between different advertisement segments.

For many frames of video content, there is minimal change from one frame to another. However, for other frames of video content, referred to as keyframes, there is a significant visual change from one frame to another. As an example, for video content that includes a program segment followed by an advertisement segment, a first frame of the advertisement segment may be significantly different from a last frame of the program segment such that the first frame is a keyframe. As another example, a frame of an advertisement segment or a program segment following a blackframe may be significantly different from the blackframe such that the frame is a keyframe. As yet another example, a segment can include a first shot followed by a second shot. A first frame of the second shot may be significantly different from a last frame of the first shot such that the first frame of the second shot is a keyframe.

The transition detector neural network of transition detection classifier 306 can be trained using a training data set. The training data set can include a sequence of media content that is annotated with information specifying which frames of the sequence of media content include transitions between different content segments. Because of a data imbalance between classes of the transition detector neural network (there may be far more frames that are considered non-transitions than transitions), the ground truth transitions frames can be expanded to be transition “neighborhoods”. For instance, for every ground truth transition frame, the two frames on either side can also labeled as transitions within the training data set. In some cases, some of the ground truth data can be slightly noisy and not temporally exact. Advantageously, the use of transition neighborhoods can help smooth such temporal noise.

Training the transition detector neural network can involve learning neural network weights that cause the transition detector neural network to provide a desired output for a desired input (e.g., correctly classify audio features and video features as being indicative of a transition from a program segment to an advertisement segment).

In some examples, the training data set can only include sequences of media content distributed on a single channel. With this approach, transition detection classifier 306 can be a channel-specific transition detector neural network that is configured to detect transitions within media content distributed on a specific channel. Alternatively, the training data set can include sequences of media content distributed on multiple different channels. With this approach, transition detection classifier 306 can be configured to detect transitions within media content distributed on a variety of channels.

The analysis module of transition detection classifier 306 can be configured to receive classification data output by the transition detector neural network, and analyze the classification data to determine whether or not the classification data for respective portions are indicative of transitions between different content segments. For instance, the classification data for a given portion can include a probability, and the analysis module can determine whether the probability satisfies a threshold condition (e.g., is greater than a threshold). Upon determining that the probability satisfies a threshold, the analysis module can output transition data indicating that the given portion includes a transition between different content segments.

In some examples, the analysis module can output transition data that identifies a location of transition within a given portion. For instance, the classification data for a given portion can include, for each frame of the given portion, a probability indicative of whether the frame is a transition between different content segments. The analysis module can determine that one of the probabilities satisfies a threshold condition, and output transition data that identifies the frame corresponding to the probability that satisfies the threshold condition as a location of a transition. As a particular example, the given portion may include forty frames, and the transition data may specify that the thirteenth frame is a transition.

In examples in which the classification data identifies two adjacent frames having probabilities that satisfy the threshold condition, the analysis module can select the frame having the greater probability of the two as the location of the transition.

As further shown in FIG. 3, the analysis module can be configured to use secondary data (e.g., keyframe data and/or blackframe data) to increase the temporal accuracy of the transition data. As one example, the analysis module can be configured to obtain keyframe data identifying whether any frames of a given portion are keyframes, and use the keyframe data to refine the location of a predicted transition. For instance, the analysis module can determine that a given portion includes a keyframe that is within a threshold distance (e.g., one second, two seconds, etc.) of a frame that the classification data identifies as a transition. Based on determining that the keyframe is within a threshold distance of the identified frame, the analysis module can refine the location of the transition to be the keyframe.

As another example, the analysis module can be configured to use secondary data identifying whether any frames within the portion of the sequence of media content are keyframes or blackframes as a check on any determinations made by the analysis module. For instance, the analysis module can filter out any predicted transition locations for which there is not a keyframe or blackframe within a threshold (e.g., two seconds, four seconds, etc.) of the predicted transition location. By way of example, after determining, using classification data output by the transition detector neural network, that a frame of a given is a transition, the analysis module can check whether the secondary data identifies a keyframe or a blackframe within a threshold distance of the frame. Further, the analysis module can then interpret a determination that there is not a keyframe or a blackframe within a threshold distance of the frame to mean that that the frame is not a transition. Or the analysis module can interpret a determination that there is a keyframe or a blackframe within a threshold distance of the frame to mean that the frame is indeed likely a transition.

Keyframe extractor 308 can be configured to output data that identifies one or more keyframes. A keyframe can include a frame that is substantially different from a preceding frame. Keyframe extractor 308 can identify keyframes in various ways. As one example, keyframe extractor 308 can analyze differences between pairs of adjacent frames to detect keyframes. In some examples, keyframe extractor 308 can also be configured to output data that identifies one or more blackframes.

In an example implementation, keyframe extractor 308 can include a blur module, a fingerprint module, a contrast module, and an analysis module. The blur module can be configured to determine a blur delta that quantifies a difference between a level of blurriness of a first frame and a level of blurriness of a second frame. The contrast module can be configured to determine a contrast delta that quantifies a difference between a contrast of the first frame and a contrast of the second frame. The fingerprint module can be configured to determine a fingerprint distance between a first image fingerprint of the first frame and a second image fingerprint of the second frame. Further, the analysis module can then be configured to use the blur delta, contrast delta, and fingerprint distance to determine whether the second frame is a keyframe. In some examples, the contrast module can also be configured to determine whether the first frame and/or the second frame is a blackframe based on contrast scores for the first frame and the second frame, respectively.

In some examples, the analysis module can output data for a video that identifies which frames are keyframes. Optionally, the data can also identify which frames are blackframes. In some instances, the output data can also identify the keyframe scores for the keyframes as well as the keyframe scores for frames that are not determined to be keyframes.

Audio fingerprint extractor 310 can be configured to generate audio fingerprints for portions of the media content. Audio fingerprint extractor 310 can extract one or more of a variety of types of audio fingerprints depending on the desired implementation. By way of example, for a given audio portion, audio fingerprint extractor 310 can divide the audio portion into a set of overlapping frames of equal length using a window function, transform the audio data for the set of frames from the time domain to the frequency domain (e.g., using a Fourier Transform), and extract features from the resulting transformations as a fingerprint. For instance, audio fingerprint extractor 310 can divide a six-second audio portion into a set of overlapping half-second frames, transform the audio data for the half-second frames into the frequency domain, and determine the location (i.e., frequency) of multiple maxima, such as the absolute or relative location of a predetermined number of spectral peaks. The determined maxima then constitute the fingerprint for the six-second audio portion.

Another example of a technique for generating an audio fingerprint that can be applied by audio fingerprint extractor 310 is disclosed in U.S. Pat. No. 9,286,902 entitled “Audio Fingerprinting,” which is hereby incorporated by reference in its entirety. Similarly, additional techniques for generating an audio fingerprint are disclosed in U.S. Patent Application Publication No. 2020/0082835 entitled “Methods and Apparatus to Fingerprint an Audio Signal via Normalization”, which is hereby incorporated by reference in its entirety. In line with that approach, audio fingerprint extractor 310 can transform an audio signal into a frequency domain, the transformed audio signal including a plurality of time-frequency bins including a first time-frequency bin, determine a first characteristic of a first group of time-frequency bins of the plurality of time-frequency bins, the first group of time-frequency bins surrounding the first time-frequency bin, and normalize the audio signal to thereby generate normalized energy values, the normalizing of the audio signal including normalizing the first time-frequency bin by the first characteristic, select one of the normalized energy values, and generate a fingerprint of the audio signal using the selected one of the normalized energy values.

Video fingerprint extractor 312 can be configured to generate video fingerprints for portions of the media content. Video fingerprint extractor 312 can extract one or more of a variety of types of audio fingerprints depending on the desired implementation. One example technique for generating a video fingerprint is described in U.S. Pat. No. 8,345,742 entitled “Method of processing moving picture and apparatus thereof,” which is hereby incorporated by reference in its entirety. In line with that approach, video fingerprint extractor 312 can generate a video fingerprint for a frame by: dividing the frame into sub-regions, calculating a color distribution vector based on averages of color components in each sub-frame, generating a first order differential of the color distribution vector, generating a second order differential of the color distribution vector, and composing a feature vector from the vectors.

Another example technique for generating a video fingerprint is described in U.S. Pat. No. 8,983,199 entitled “Apparatus and method for generating image feature data,” which is hereby incorporated by reference in its entirety. In line with that approach, video fingerprint extractor 312 can generate a video fingerprint for a frame by: identifying one or more feature points in the frame, extracting information describing the feature points, filtering the identified feature points, and generating feature data based on the filtered feature points.

In some examples, feature extraction module 300 can be configured to extract and output other types of features instead of or in addition to those shown in FIG. 3. For instance, any of the features extracted by video and audio feature extractor 304 can be output as features by feature extraction module 300. In some instances, video and audio feature extractor 304 can be configured to identify human faces and output features related to the identified human faces (e.g., expressions). In some instances, video and audio feature extractor 304 can be configured to identify queue tones and output features related to the queue tones. In some instances, video and audio feature extractor 304 can be configured to identify silence gaps and output features related to the silence gaps.

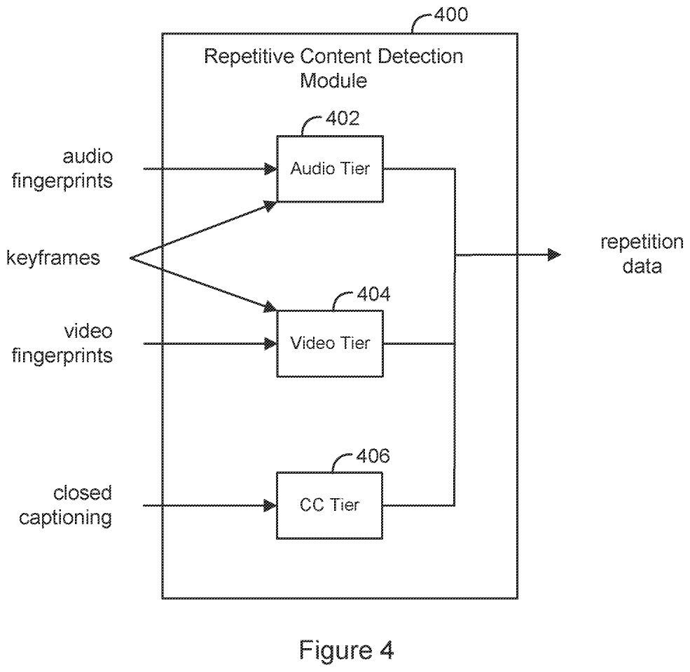

FIG. 4 is a simplified block diagram of an example repetitive content detection module 400. Repetitive content detection module 400 can perform various acts and/or functions related to generating repetition data. Repetitive content detection module 400 is an example configuration of repetitive content detection module 204 of FIG. 2.

As shown in FIG. 4, repetitive content detection module 400 can include an audio tier 402, a video tier 404, and a closed captioning (CC) tier 406. Audio tier 402 can be configured to generate fingerprint repetition data using audio fingerprints. Similarly, video tier 404 can be configured to generate fingerprint repetition data using video fingerprints. Further, CC tier 406 can be configured to generate closed captioning repetition data using closed captioning.

For multiple portions of the media content, repetitive content detection module 400 can identify boundaries of the portion and respective counts indicating how many times the portions are repeated within the media content or a subset of the media content. For instance, the repetition data for a given portion can include information specifying that the portion has been repeated ten times within a given time period (e.g., one or more days, one or more weeks, etc.). Further, the repetition data for a given portion can also include a list identifying other instances in which the portion is repeated (e.g., a list of other portions of the media content matching the portion).

As a particular example, a portion of media content can include a ten-minute portion of a television program that has been presented multiple times on a single channel during the past week. Hence, the fingerprint repetition data for the portion of media content can include a list of each other time the ten-minute portion of the television program was presented. As another example, a portion of media content can include a thirty-second advertisement that has been presented multiple times during the past week on multiple channels. Hence, the repetition data for the portion of media content can include a list of each other time the thirty-second advertisement was presented.

Repetitive content detection module 400 can be configured to use keyframes of video content to generate repetition data. For instance, repetitive content detection module can be configured to identify a portion of video content between two adjacent keyframes of the keyframes, and search for other portions within the video content having features matching features for the portion.

In one example, audio tier 402 can be configured to create queries using the audio fingerprints and the keyframes. For instance, for each keyframe, audio tier 402 can define a query portion as the portion of the media content spanning from the keyframe to a next keyframe, and use the audio fingerprints for the query portion to search for matches to the query portion within an index of audio fingerprints. Audio tier 402 can determine whether portions match the query portion by calculating a similarity measure that compares audio fingerprints of the query portion with audio fingerprints of a candidate matching portion, and comparing the similarity measure to a threshold. In some examples, the audio fingerprints in the index of audio fingerprints may include audio fingerprints for media content presented on a variety of channels over a period of time. When performing the query, audio tier 402 may limit the results to portions that correspond to media content that was broadcast during a given time period. In some instances, audio tier 402 may update the index of audio fingerprints on a periodic or as-needed basis, such that old audio fingerprints are removed from the index of audio fingerprints.

Additionally or alternatively, video tier 404 can be configured to create queries using the video fingerprints and the keyframes. For instance, for each keyframe in the transition data, video tier 404 can define a query portion as the portion of the media content spanning form the keyframe to a next keyframe, and use the video fingerprints for the query portion to search for matches to the query portion within an index of video fingerprints.

CC tier 406 can be configured to generate closed captioning repetition data using a text indexer. By way of example, a text indexer can be configured to maintain a text index. The text index can store closed captioning repetition data for a set of video content presented on a single channel or multiple channels over a period of time (e.g., one week, eighteen days, one-month, etc.).

Closed captioning for video content can include text that represents spoken dialog, sound effects, or music, for example. Closed captioning can include lines of text, and each line of text can have a timestamp indicative of a position within video content. Within the set of video content indexed by the text indexer, some lines of closed captioning may be repeated. For instance, a line of closed captioning can be repeated multiple times on a single channel and/or multiple times across multiple channels. For such lines of closed captioning as well as lines of closed captioning that are not repeated, the text index can store closed captioning repetition data, such as a count of a number of times the line of closed captioning occurs per channel, per day, and/or a total number of times the line of closed captioning occurs within the text index.

The text indexer can update the counts when new data is added to the text index. Additionally or alternatively, the text indexer can update the text index periodically (e.g., daily). With this arrangement, at any given day, the text index can store data for a number X days prior to the current day (e.g., the previous ten days, the previous fourteen days, etc.). In some examples, the text indexer can post-process the text index. The post-processing can involve discarding lines or sub-sequences of lines having a count that is below a threshold (e.g., five). This can help reduce the size of the text index.

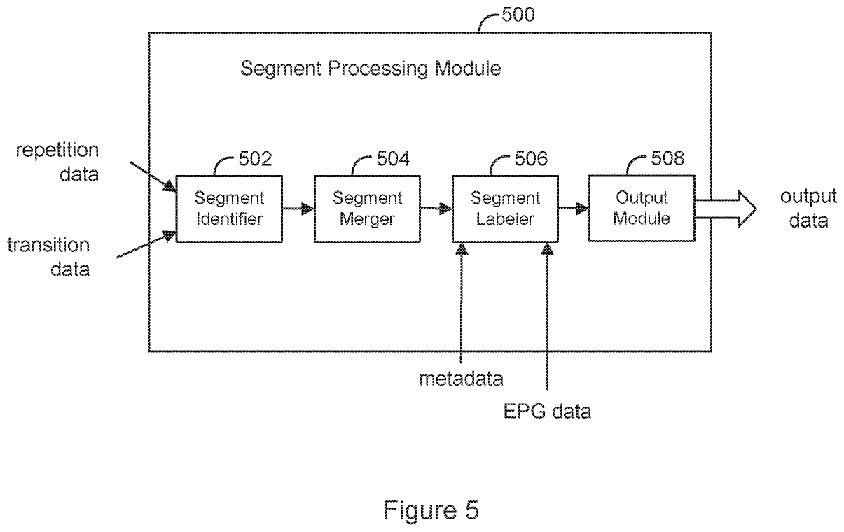

FIG. 5 is a simplified block diagram of an example segment processing module 500. Segment processing module 500 can perform various acts and/or functions related to identifying and labeling portions of media content. Segment processing module 500 is an example configuration of segment processing module 206 of FIG. 2.

As shown in FIG. 5, segment processing module 500 can include a segment identifier 502, a segment merger 504, a segment labeler 506, and an output module 508. Each of segment identifier 502, segment merger 504, segment labeler 506, and output module can be implemented as a computing system. For instance, one or more of the components depicted in FIG. 5 can be implemented using hardware (e.g., a processor of a machine, a field-programmable gate array (FPGA), or an application-specific integrated circuit (ASIC), or a combination of hardware and software. Moreover, any two or more of the components depicted in FIG. 5 can be combined into a single component, and the function described herein for a single component can be subdivided among multiple components.

Segment processing module 500 can be configured to receive repetition data and transition data for media content, analyze the received data, and output data regarding the media content. For instance, segment processing module 500 can use fingerprint repetition data and/or closed captioning repetition data for a portion of video content to identify the portion of video content as either a program segment or an advertisement segment. Based on identifying a portion of media content as a program segment, segment processing module 500 can also merge the portion with one or more adjacent portions of media content that have been identified as program segments. Further, segment processing module 500 can determine that the program segment corresponds to a program specified in an EPG, and store an indication of the portion of media content in a data file for the program. Alternatively, based on identifying the portion of media content as an advertisement segment, segment processing module 500 can obtain metadata for the portion of media content. Further, computing system 200 can store an indication of the portion and the metadata in a data file for the portion.

Segment identifier 502 can be configured to receive a section of media content as input, and obtain fingerprint repetition data and/or closed captioning repetition data for one or more portions of the section of media content. For instance, the section of media content can be an hour-long video, and the segment identifier module can obtain fingerprint repetition data and/or closed captioning repetition data for multiple portions within the hour-long video.

The section of media content can include associated metadata, such as a timestamp that identifies when the section of media content was presented and a channel that identifies the channel on which the section of media content was presented. The fingerprint repetition data for a portion of media content can include a list of one or more other portions of media content matching the media content. Further, for each other portion of media content in a list of other portions of media content, the fingerprint repetition data can include a reference identifier that identifies the portion. One example of a reference identifier is a Tribune Media Services identifier (TMS ID) that is assigned to a television show. A TMS ID can be retrieved from a channel lineup for a geographic area that specifies the TMS ID of different programs that are presented on different channels at different times.

Segment identifier 502 can be configured to retrieve the fingerprint repetition data for a portion of media content from one or more repetitive content databases, such as a video repetitive content database and/or an audio repetitive content database. By way of example, a video repetitive content database can store video fingerprint repetition data for a set of video content stored in a video database. Similarly, an audio repetitive content database can store audio fingerprint repetition data for a set of media content.

Additionally or alternatively, segment identifier 502 can be configured to retrieve closed captioning repetition data for a portion of media content from a database. By way of example, the portion can include multiple lines of closed captioning. For each of multiple lines of the closed captioning, segment identifier 502 can retrieve, from a text index, a count of a number of times the line of closed captioning occurs in the text index. Metadata corresponding to the count can specify whether the count is per channel or per day.

In some instances, retrieving the closed captioning repetition data can include pre-processing and hashing lines of closed captioning. This can increase the ease (e.g., speed) of accessing the closed captioning repetition data for the closed captioning.

Pre-processing can involve converting all text to lowercase, removing non-alphanumeric characters, removing particular words (e.g., “is”, “a”, “the”, etc.) and/or removing lines of closed captioning that only include a single word. Pre-processing can also involve dropping text segments that are too short (e.g., “hello”).

Hashing can involve converting a line or sub-sequence of a line of closed captioning to a numerical value or alphanumeric value that makes it easier (e.g., faster) to retrieve the line of closed captioning from the text index. In some examples, hashing can include hashing sub-sequences of lines of text, such as word or character n-grams. Additionally or alternatively, there could be more than one sentence in a line of closed captioning. For example, “Look out! Behind you!” can be transmitted as a single line. Further, the hashing can then include identifying that the line includes multiple sentences, and hashing each sentence individually.

Segment identifier 502 can also be configured to select a portion of media content using transition data for a section of media content. By way of example, the transition data can include predicted transitions between different content segments, and segment identifier 502 can select a portion between two adjacent predicted transitions. In line with the discussion above, the predicted transitions can include transitions from a program segment to an advertisement segment, an advertisement segment to a program segment, an advertisement segment to another advertisement segment, and/or a program segment to another program segment.

By way of example, for an hour-long section of media content, the prediction transition data can include predicted transitions at twelve minutes, fourteen minutes, twenty-two minutes, twenty-four minutes, forty-two minutes, and forty-four minutes. Accordingly, segment identifier 502 can select the first twelve minutes of the section of media content as a portion of video content to be analyzed. Further, segment identifier 502 can also use the predicted transition data to select other portions of the section of video content to be analyzed.

Segment identifier 502 can be configured to use fingerprint repetition data for a portion of media content to classify the portion as either a program segment or an advertisement segment. By way of example, segment identifier 502 can identify a portion of media content as a program segment rather than an advertisement segment based on a number of unique reference identifiers within the list of other portions of media content relative to a total number of reference identifiers within the list of other portions of media content. For instance, segment identifier 502 can identify the portion of media content as a program segment based on determining that a ratio of the number of unique reference identifiers to the total number of reference identifiers satisfies a threshold (e.g., is less than a threshold).

When a portion of video content is a program segment, the portion of video content is likely to have the same reference identifier each time the portion of video content is presented, yielding a low number of unique reference identifiers and a relatively low ratio. Whereas, if a portion of video content is an advertisement segment, and that advertisement segment is presented during multiple different programs, the portion of video content can have different reference identifiers each time the portion of video content is presented, yielding a high number of unique reference identifiers and a relatively higher ratio. As an example, a list of matching portions of video content for a portion of video content can include five other portions of video content. Each other portion of video content can have the same reference identifier. With this example, the number of unique reference identifiers is one, and the total number of reference identifiers is five. Further, the ratio of unique reference identifiers to total number of reference identifiers is 1:5 or 0.2. If any of the portions in the list of matching portions of video content had different reference identifiers, the ratio would be higher.

Segment identifier 502 can also be configured to use other types of data to classify portions of video content as program segments or advertisement segments. As one example, segment identifier 502 can be configured to use closed captioning repetition data to identify whether a portion of video content is a program segment or an advertisement segment. As another example, segment identifier 502 can be configured to identify a portion of video content as a program segment rather than an advertisement segment based on logo coverage data for the portion of video content. As another example, segment identifier 502 can be configured to identify a portion of video content as an advertisement segment rather than a program segment based on a length of the portion of video content. After identifying one or more portions of video content as program segments and/or advertisement segments, segment identifier 502 can output the identified segments to segment merger 504 for use in generating merged segments.

Segment merger 504 can merge the identified segments in various ways. As one example, segment merger 504 can combine two adjacent portions of media content that are identified as advertisement segments based on the number of correspondences between a first list of matching portions for a first portion of the two adjacent portions and a second list of matching portions for a second portion of the two adjacent portions. For instance, each portion in the first list and the second list can include a timestamp (e.g., a date and time) indicative of when the portion was presented. Segment merger 504 can use the timestamps to search for correspondences between the first list and the second list. For each portion in the first list, segment merger 504 can use the timestamp of the portion in the first list and timestamps of the portions in the second list to determine whether the second list includes a portion that is adjacent to the portion in the first list. Based on determining that a threshold percentage of the portions in the first list have adjacent portions in the second list, segment merger 504 can merge the first portion and the second portion together.

As another example, segment merger 504 can combine two or more adjacent portions of media content that are identified as program segments. As still another example, segment merger 504 can combine a first portion that is identified as a program segment, a second portion that is adjacent to and subsequent to the first portion and identified as an advertisement segment, and a third portion that is adjacent to and subsequent to the second portion and identified as a program segment together and identify the merged portion as a program segment. For instance, based on determining that the second portion that is between the first portion and the third portion has a length that is less than a threshold (e.g., less than five seconds), segment merger 504 can merge the first, second, and third portions together as a single program segment. Segment merger 504 can make this merger based on an assumption that an advertisement segment between two program segments is likely to be at least a threshold length (e.g., fifteen or thirty seconds).

In some examples, merging adjacent portions of video content can include merging portions of adjacent sections of media content (e.g., an end portion of a first section of video content and a beginning portion of a second section of video content). After merging one or more segments, segment merger 504 can output the merged segments to segment labeler 506. The merged segments can also include segments that have not been merged with other adjacent portions of media content.

Segment labeler 506 can be configured to use EPG data to determine that a program segment corresponds to a program specified in an EPG. By way of example, for a given program identified in EPG data, segment labeler 506 can use a timestamp range and channel of the program to search for portions of media content that have been identified as program segments and match the timestamp range and channel. For each of one or more portions of media content meeting this criteria, segment labeler 506 can store metadata for the given program in association with portion of media content. The metadata can include a title of the given program as specified in the EPG data, for instance.

As a particular example, EPG data may indicate that the television show Friends was presented on channel 5 between 6:00 pm and 6:29:59 pm on March 5. Given this information, segment labeler 506 may search for any portions of video content that have been identified as program segments and for which at least part of the portion of video content was presented during the time range. The search may yield three different portions of video content: a first portion, a second portion and a third portion. Based on the three portions meeting the search criteria, segment labeler 506 can store metadata for the given program in association with the first, second, and third portions.

Additionally or alternatively, segment labeler 506 can be configured to associate metadata with portions of media content that are identified as advertisement segments. The metadata can include a channel on which a portion of media content is presented and/or a date and time on which the portion of media content is presented.

As further shown in FIG. 5, output module 508 can be configured to receive labeled segments as input and output one or more data files. In one example, output module 508 can output a data file for a given program based on determining that the labeled segments are associated with the given program. For instance, output module 508 can determine that the labeled segments include multiple segments that are labeled as corresponding to a given program. For each of the multiple segments that are labeled as corresponding to the given program, output module 508 can then store an indication of the segment in a data file for the given program. The indication of the segment stored in the data file can include any type of information that can be used to retrieve a portion of video content from a database. For instance, the indication can include an identifier of a section of video content that includes the segment, and boundaries of the segment within the section of video content. The identifier of the section of video content can include an address, URL, or pointer, for example.

For portions of media content that are identified as advertisement segments, output module 508 can output data files that include an identifier of a section of media content from a database as well as metadata. In some instances, the data files for advertisement segments can also include information identifying that the data files correspond to an advertisement segment rather than a program segment. For instance, each advertisement segment can be assigned a unique identifier that can be included in a data file. Further, in some instances, each advertisement segment can be stored in an individual data file. In other words, there may be just a single advertisement segment per data file. Alternatively, multiple advertisement segments can be stored in the same data file.

In some examples, output module 508 can use a data file for a program to generate a copy of the program. For instance, output module 508 can retrieve and merge together all of the portions of media content specified in a data file. Advantageously, the generated copy can be a copy that does not include any advertisement segments.

Similarly, rather than generating a copy of the program, output module 508 can use the data file to generate fingerprints of the program. For instance, output module 508 can use the data file to retrieve the portions of media content specified in the data file, fingerprint the portions, and store the fingerprints in a database in association with the program label for the program. The fingerprints can include audio fingerprints and/or video fingerprints.

Additionally or alternatively, output module 508 can use a data file for a program to generate copies of media content that was presented during advertisement breaks for the program. For instance, the computing system can identify gaps between the program segments based on the boundaries of the program segments specified in the data file, and retrieve copies of media content that was presented during the gaps between the program segments.

### III. Example Operations

The computing system 200 and/or components thereof can be configured to perform and/or can perform one or more operations. Examples of these operations and related features will now be described.

A. Operations Related to Determining a Blur Delta

As noted above, keyframe extractor 308 of FIG. 3 can include a blur module configured to determine a blur delta for a pair of adjacent frames of a video. The blur delta can quantify a difference between a level of blurriness of a first frame and a level of blurriness of a second frame. The level of blurriness can quantify gradients between pixels of a frame. For instance, a blurry frame may have many smooth transitions between pixel intensity values of neighboring pixels. Whereas, a frame having a lower level of blurriness might have gradients that are indicative of more abrupt changes between pixel intensity values of neighboring pixels.

In one example, for each frame of a pair of frames, the blur module can determine a respective blur score for the frame. Further, the blur module can then determine a blur delta by comparing the blur score for a first frame of the pair of frames with a blur score for a second frame of the pair of frames.

The blur module can determine a blur score for a frame in various ways. By way of example, the blur module can determine a blur score for a frame based on a discrete cosine transform (DCT) of pixel intensity values of the frame. For instance, the blur module can determine a blur score for a frame based on several DCTs of pixel intensity values of a downscaled, grayscale version of the frame. For a grayscale image, the pixel value of each pixel is a single number that represents the brightness of the pixel. A common pixel format is a byte image, in which the pixel value for each pixel is stored as an 8-bit integer giving a range of possible values from 0 to 255. A pixel value of 0 corresponds to black, and a pixel value of 255 corresponds to white. Further, pixel values in between 0 and 255 correspond to different shades of gray.

An example process for determining a blur score includes converting a frame to grayscale and downscaling the frame. Downscaling the frame can involve reducing the resolution of the frame by sampling groups of adjacent pixels. This can help speed up the processing of functions carried out in subsequent blocks.

The process also includes calculating a DCT of the downscaled, grayscale frame. Calculating the DCT transforms image data of the frame from the spatial domain (i.e., x-y) to the frequency domain, and yields a matrix of DCT coefficients. The process then includes transposing the DCT. Transposing the DCT involves transposing the matrix of DCT coefficients. Further, the process then includes calculating the DCT of the transposed DCT. Calculating the DCT of the transposed DCT involves calculating the DCT of the transposed matrix of DCT coefficients, yielding a second matrix of DCT coefficients.

The process then includes calculating the absolute value of each coefficient of the second matrix of DCT coefficients, yielding a matrix of absolute values. Further, the process includes summing the matrix of absolute values and summing the upper-left quarter of the matrix of absolute values. Finally, the process includes calculating the blur score using the sum of the matrix of absolute values and the sum of the upper-left quarter of the matrix of absolute values. For instance, the blur score can be obtained by subtracting the sum of the upper-left quarter of the matrix of absolute values from the sum of the matrix of absolute values, and dividing the difference by the sum of the matrix of absolute values.

In the second matrix of DCT coefficients, high frequency coefficients are located in the upper-left quarter of the matrix. A frame with a relatively high level of blurriness generally includes a low number of high frequency coefficients, such that the sum of the upper-left quarter of the matrix of absolute values is relatively low, and the resulting blur score is high. Whereas, a frame with a lower level of blurriness, such as a frame with sharp edges or fine-textured features, generally includes more high frequency coefficients, such that the sum of the upper-left quarter is higher, and the resulting blur score is lower.

B. Operations Related to Determining a Contrast Delta

As also noted above, keyframe extractor 308 can include a contrast module configured to determine a contrast delta for a pair of adjacent frames of a video. The contrast delta can quantify a difference between a contrast of a first frame and a contrast a second frame. Contrast can quantify a difference between a maximum intensity and minimum intensity within a frame.

In one example, for each frame of a pair of frames, the contrast module can determine a respective contrast score for the frame. Further, the contrast module can then determine a contrast delta by comparing the contrast score for a first frame of the pair of frames with a contrast score for a second frame of the pair of frames.

The contrast module can determine a contrast score for a frame in various ways. By way of example, the contrast module can determine a contrast score based on a standard deviation of a histogram of pixel intensity values of the frame.

An example process for determining a contrast score includes converting a frame to grayscale and downscaling the frame. The process then includes generating a histogram of the frame. Generating the histogram can involve determining the number of pixels in the frame at each possible pixel value (or each of multiple ranges of possible pixel values). For an 8-bit grayscale image, there are 256 possible pixel values, and the histogram can represent the distribution of pixels among the 256 possible pixel values (or multiple ranges of possible pixel values).

The process also includes normalizing the histogram. Normalizing the histogram can involve dividing the numbers of pixels in the frame at each possible pixel value by the total number of pixels in the frame. In addition, the process includes calculating an average of the normalized histogram. Further, the process includes applying a bell curve across the normalized histogram. In one example, applying the bell curve can highlight values that are in the gray range. For instance, the importance of values at each side of the histogram (near black or near white) can be reduced, while the values in the center of the histogram are left basically unfiltered. The average of the normalized histogram can be used as the center of the histogram.

The process then includes calculating a standard deviation of the resulting histogram, and calculating a blur score using the standard deviation. For instance, the normalized square root of the standard deviation may be used as the contrast score.

In some examples, the contrast module can identify a blackframe based on a contrast score for a frame. For instance, the contrast module can determine that any frame having a contrast score below a threshold (e.g., 0.1, 0.2, 0.25, etc.) is a blackframe.

C. Operations Related to Determining a Fingerprint Distance

As noted above, keyframe extractor 308 can include a fingerprint module configured to determine a fingerprint distance for a pair of adjacent frames of a video. The fingerprint distance can be a distance between an image fingerprint of a first frame and an image fingerprint of a second frame.

In one example, for each frame of a pair of frames, the fingerprint module can determine a respective image fingerprint for the frame. Further, the fingerprint module can then determine a fingerprint distance between the image fingerprint for a first frame of the pair of frames and the image fingerprint for a second frame of the pair of frames. For instance, the fingerprint module can be configured to determine a fingerprint distance using a distance measure such as the Tanimoto distance or the Manhattan distance.

The fingerprint module can determine an image fingerprint for a frame in various ways. As one example, the fingerprint module can extract features from a set of regions within the frame, and determine a multi-bit signature based on the features. For instance, the fingerprint module can be configured to extract Haar-like features from regions of a grayscale version of a frame. A Haar-like feature can be defined as a difference of the sum of pixel values of a first region and a sum of pixel values of a second region. The locations of the regions can be defined with respect to a center of the frame. Further, the first and second regions used to extract a given Haar-like feature may be the same size or different sizes, and overlapping or non-overlapping.

As one example, a first Haar-like feature can be extracted by overlaying a 1×3 grid on the frame, with the first and third columns of the grid defining a first region and a middle column of the grid defining a second region. A second Haar-like feature can also be extracted by overlaying a 3×3 grid on the frame, with a middle portion of the grid defining a first region and the eight outer portions of the grid defining a second region. A third Haar-like feature can also be extracted using the same 3×3 grid, with a middle row of the grid defining a first region and a middle column of the grid defining a second region. Each of the Haar-like features can be quantized to a pre-set number of bits, and the three Haar-like features can then be concatenated together, forming a multi-bit signature.

Further, in some examples, before extracting Haar-like features, a frame can be converted to an integral image, where each pixel is the cumulated values of the pixels above and to the left as well as the current pixel. This can improve the efficiency of the fingerprint generation process.

D. Operations Related to Determining a Keyframe Score

As noted above, keyframe extractor 308 can include an analysis module configured to determine a keyframe score for a pair of adjacent frames of a video. The keyframe score can be determined using a blur delta for the pair of frames, a contrast delta for the pair of frames, and a fingerprint distance for the pair of frames. For instance, the analysis module can determine a keyframe score based on weighted combination of the blur delta, contrast delta, and fingerprint distance.

In one example, for a current frame and a previous frame of a pair of frames, a keyframe score can be calculated using the following formula:

keyframeScore=(spatial_distance*_w1)+(blur_ds*w2)+(constrast_ds*w3),

where:

spatial_distance is the fingerprint distance score for a current frame and the previous frame,

w1 is a first weight,

blur_ds is the delta of the blur score of the current frame and the previous frame,

w2 is a second weight,

constrast_ds is the delta of the contrast sore for the current frame and the previous frame, and

w3 is a third weight.

In one example implementation, the values for w1, w2, and w3, may be 50%, 25%, and 25%, respectively.

Further, in some examples, the analysis module can be configured to use a different set of information to derive the keyframe score for a pair of frames. For instance, the analysis module can be configured to determine another difference metric, and replace the blur delta, contrast delta, or the fingerprint distance with the other difference metric or add the other difference metric to the weighted combination mentioned above.

One example of another difference metric is an object density delta that quantifies a difference between a number of objects in a first frame and a number of objects in a second frame. The number of objects (e.g., faces, buildings, cars) in a frame can be determined using an object detection module, such as a neural network object detection module or a non-neural object detection module.

Still further, in some examples, rather than using grayscale pixel values to derive the blur delta, contrast delta, and fingerprint distance, the analysis module can combine individual color scores for each of multiple color channels (e.g., red, green, and blue) to determine the keyframe score. For instance, the analysis module can combine a red blur delta, a red contrast delta, and a red fingerprint distance to determine a red component score. Further, the analysis module can combine a blue blur delta, a blue contrast delta, and a blue fingerprint distance to determine a blue component score. And the analysis module can combine a green blur delta, a green contrast delta, and a green fingerprint distance to determine a green component score. The analysis module can then combine the red component score, blue component score, and green component score together to obtain the keyframe score.

The analysis module can determine whether a second frame of a pair of frames is a keyframe by determining whether the keyframe score satisfies a threshold condition (e.g., is greater than a threshold). For instance, the analysis module can interpret a determination that a keyframe score is greater than a threshold to mean that the second frame is a keyframe. Conversely, the analysis module can interpret a determination that a keyframe score is less than or equal to the threshold to mean that the second frame is not a keyframe. The value of the threshold may vary depending on the desired implementation. For example, the threshold may be 0.2, 0.3, or 0.4.

E. Operations Related to Creating or Updating a Text Index

As noted above, the text indexer of CC tier 406 can maintain a text index. An example process for creating a text index includes receiving closed captioning. The closed captioning can include lines of text, and each line of text can have a timestamp indicative of a position within a sequence of media content. In some examples, receiving the closed captioning can involve decoding the closed captioning from a sequence of media content.

The process also includes identifying closed captioning metadata. The closed captioning can include associated closed captioning metadata. The closed captioning metadata can identify a channel on which the sequence of media content is presented and/or a date and time that the sequence of media content is presented. In some examples, identifying the closed captioning metadata can include reading data from a metadata field associated with a closed captioning record. In other examples, identifying the closed captioning metadata can include using an identifier of the sequence of media content to retrieve closed captioning metadata from a separate database that maps identifiers of sequences of media content to corresponding closed captioning metadata.

The process also includes pre-processing the closed captioning. Pre-processing can involve converting all text to lowercase, removing non-alphanumeric characters, removing particular words (e.g., “is”, “a”, “the”, etc.) and/or removing lines of closed captioning that only include a single word. Pre-processing can also involve dropping text segments that are too short (e.g., “hello”).

In addition, the process includes hashing the pre-processed closed captioning. Hashing can involve converting a line or sub-sequence of a line of closed captioning to a numerical value or alphanumeric value that makes it easier (e.g., faster) to retrieve the line of closed captioning from the text index. In some examples, hashing can include hashing sub-sequences of lines of text, such as word or character n-grams. Additionally or alternatively, there could be more than one sentence in a line of closed captioning. For example, “Look out! Behind you!” can be transmitted as a single line. Further, the hashing can then include identifying that the line includes multiple sentences, and hashing each sentence individually.

The process then includes storing the hashed closed captioning and corresponding metadata in a text index. The text index can store closed captioning and corresponding closed captioning metadata for sequences of media content presented on a single channel or multiple channels over a period of time (e.g., one week, eighteen days, one-month, etc.). For lines of closed captioning that are repeated, the text index stores store closed captioning repetition data, such as a count of a number of times the line of closed captioning occurs per channel, per day, and/or a total number of times the line of closed captioning occurs within the text index.

F. Operations Related to Classifying a Portion of Video Content

As noted above, a computing system, such as segment identifier 502 of FIG. 5, can be configured to classify a portion of video content as either an advertisement segment or a program segment. An example process for classifying a portion of video content includes determining whether a reference identifier ratio is less than a threshold. In line with the discussion above, the fingerprint repetition data for a portion of video content can include a list of other portions of video content matching a portion of video content as well as reference identifiers for the other portions of video content. The reference identifier ratio for a portion of video content is a ratio of i) the number of unique reference identifiers within a list of other portions of video content matching the portion of video content relative to ii) the total number of reference identifiers within the list of other portions of video content.

As an example, a list of other portions of video content matching a portion of video content may include ten other portions of video content. Each of the ten other portions can have a reference identifier, such that the total number of reference identifiers is also ten. However, the ten reference identifiers might include a first reference identifier, a second reference identifier that is repeated four times, and a third reference identifier that is repeated five times, such that there are just three unique reference identifiers. With this example, the reference identifier ratio is three to ten, or 0.3 when expressed in decimal format.

Determining whether a reference identifier ratio is less than the threshold can involve comparing the reference identifier ratio in decimal format to a threshold. Based on determining that a reference identifier ratio for the portion is less than a threshold, the computing system can classify the portion as a program segment. Whereas, based on determining that the reference identifier ratio is not less than the threshold, the computing system can then determine whether logo coverage data for the portion satisfies a threshold.

The logo coverage data is indicative of a percent of time that a logo overlays the portion of video content. Determining whether the logo coverage data satisfies a threshold can involve determining whether a percent of time that a logo overlays the portion is greater than a threshold (e.g., ninety percent, eighty-five percent, etc.). One example of a logo is a television station logo.

The logo coverage data for the portion of video content can be derived using a logo detection module. The logo detection module can use any of a variety of logo detection techniques to derive the logo coverage data, such as fingerprint matching to a set of known channel logos or use of a neural network that is trained to detect channel logos. Regardless of the manner in which the logo coverage data is generated, the logo coverage data can be stored in a logo coverage database. Given a portion of video content to be analyzed, the computing system can retrieve logo coverage data for the portion of video content from the logo coverage database.

Based on determining that the logo coverage data for the portion satisfies the threshold, the computing system can classify the segment as a program segment. Whereas, based on determining that the logo coverage data does not satisfy the threshold, the computing system can then determine whether a number of other portions of video content matching the portion of video content is greater than a threshold number and a length of the portion of video content is less than a first threshold length (such as fifty seconds, seventy-five seconds, etc.).

Based on determining that the number of other portions is greater than the threshold number and the length of the portion is less than the first threshold length, the computing system can classify the portion as an advertisement segment. Whereas, based on determining that the number of other portions is not greater than the threshold or the length is not less than the first threshold length, the computing system can then determine whether the length of the portion is less than a second threshold length. The second threshold length can be the same as the first threshold length. Alternatively, the second threshold length can be less than first threshold length. For instance, the first threshold length can be ninety seconds and the second threshold length can be forty-five seconds. In some instances, the second threshold length can be greater than the first threshold length.

Based on determining that the length of the portion is less than the second threshold length, the computing system can classify the portion as an advertisement segment. Whereas, based on determining that the length of the portion is not less than the second threshold length, the computing system can classify the portion as a program segment.

A computing system can also classifying a portion of video content in other ways. For instance, another example process for classifying a portion of video content includes retrieving closed captioning repetition data and generating features from closed captioning repetition data.

The computing system can generate features in various ways. For instance, the closed captioning may correspond to a five-second portion and include multiple lines of closed captioning. Each line of closed captioning can have corresponding closed captioning repetition data retrieved from a text index. The closed captioning repetition data can include, for each line: a count, a number of days on which the line occurs, and/or a number of channels on which the line occurs. The computing system can use the counts to generate features. Example features include: the counts, an average count, an average number of days, and/or an average number of channels. Optionally, the computing system can generate features from the closed captioning.

The process can also include transforming the features. The features to be transformed can include the previously-generated features. In addition, the features can include lines of closed captioning and/or raw closed captioning repetition data. In sum, the features to be transformed can include one or any combination of lines of closed captioning, raw closed captioning repetition data, features derived from lines of closed captioning, and features derived from closed captioning repetition data.

Transforming the features can involve transforming the generated features to windowed features. Transforming the generated features to windowed features can include generating windowed features for sub-portions of the portion. For example, for a five-second portion, a three-second window can be used. With this approach, a first set of windowed features can be obtained by generating features for the first three seconds of the portion, a second set of windowed features can be obtained by generating features for the second, third, and fourth seconds of the portion, and a third set of windowed features can be obtained by generating features for the last three seconds of the portion. Additionally or alternatively, generating features can include normalizing the features.

The process then includes classifying the features. By way of example, the features can be provided as input to a classification model. The classification model can be configured to output classification data indicative of a likelihood of the features being characteristic of a program segment and/or a likelihood of the features being characteristic of an advertisement segment. For instance, the classification model can output a probability that the features are characteristic of a program segment and/or a probability that the features are characteristic of an advertisement segment.

In line with the discussion above, the classification model can take the form of a neural network. For instance, the classification model can include a recurrent neural network, such as a long short-term memory (LSTM). Alternatively, the classification model can include a feedforward neural network.

The process then includes analyzing the classification data. For instance, the computing system can use the classification data output by the classification model to determine whether the portion is a program segment and/or whether the segment is an advertisement segment.

By way of example, determining whether the portion is a program segment can involve comparing the classification data to a threshold. In an example in which multiple sets of windowed features are provided as input to the classification model, the classification model can output classification data for each respective set of windowed features. Further, the computing system can then aggregate the classification data to determine whether the portion is a program segment. For instance, the computing system can average the probabilities, and determine whether the average satisfies a threshold. As another example, the computing system can compare each individual probability to a threshold, determine whether more probabilities satisfy the threshold or more probabilities do not satisfy the threshold, and predict whether the portion is a program segment based on whether more probabilities satisfy the threshold or more probabilities do not satisfy the threshold. In a similar manner, the computing system can compare one or more probabilities to a threshold to determine whether the portion is an advertisement segment.

G. Example Method

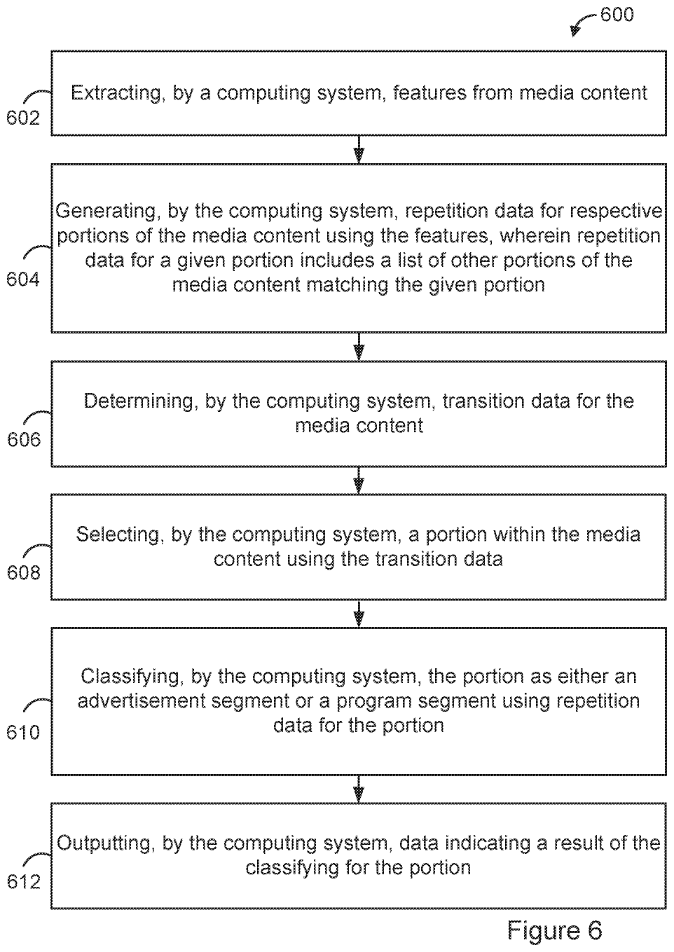

FIG. 6 is a flow chart of an example method 600. Method 600 can be carried out by a computing system, such as computing system 200 of FIG. 2. At block 602, method 600 includes extracting, by a computing system, features from media content. At block 604, method 600 includes generating, by the computing system, repetition data for respective portions of the media content using the features. Repetition data for a given portion includes a list of other portions of the media content matching the given portion. At block 606, method 600 includes determining, by the computing system, transition data for the media content. At block 608, method 600 includes selecting, by the computing system, a portion within the media content using the transition data. At block 610, method 600 includes classifying, by the computing system, the portion as either an advertisement segment or a program segment using repetition data for the portion. And at block 612, method 600 includes outputting, by the computing system, data indicating a result of the classifying for the portion.

### IV. Example Variations

Although some of the acts and/or functions described in this disclosure have been described as being performed by a particular entity, the acts and/or functions can be performed by any entity, such as those entities described in this disclosure. Further, although the acts and/or functions have been recited in a particular order, the acts and/or functions need not be performed in the order recited. However, in some instances, it can be desired to perform the acts and/or functions in the order recited. Further, each of the acts and/or functions can be performed responsive to one or more of the other acts and/or functions. Also, not all of the acts and/or functions need to be performed to achieve one or more of the benefits provided by this disclosure, and therefore not all of the acts and/or functions are required.

Although certain variations have been discussed in connection with one or more examples of this disclosure, these variations can also be applied to all of the other examples of this disclosure as well.

Although select examples of this disclosure have been described, alterations and permutations of these examples will be apparent to those of ordinary skill in the art. Other changes, substitutions, and/or alterations are also possible without departing from the invention in its broader aspects as set forth in the following claims.

1. A method comprising:
extracting, by a computing system, features from media content;
generating, by the computing system, repetition data for respective portions of the media content using the features, wherein repetition data for a given portion comprises a list of other portions of the media content matching the given portion;
determining, by the computing system, transition data for the media content;
selecting, by the computing system, a portion within the media content using the transition data;
classifying, by the computing system, the portion as either an advertisement segment or a program segment using repetition data for the portion; and
outputting, by the computing system, data indicating a result of the classifying for the portion.

2. The method of claim 1, wherein:
extracting the features comprises extracting fingerprints, and
generating the repetition data comprises generating the repetition data using the fingerprints.

3. The method of claim 1, wherein:
extracting the features comprises extracting closed captioning, and
generating the repetition data comprises generating the repetition data using the closed captioning.

4. The method of claim 1, wherein:
extracting the features comprises extracting keyframes, and
generating the repetition data comprises:
identifying a portion between two adjacent keyframes of the keyframes; and
searching for other portions within the media content having features matching features for the portion.

5. The method of claim 1, wherein:
the transition data comprises predicted transitions between different content segments, and
selecting the portion comprises selecting a portion between two adjacent predicted transitions of the predicted transitions.

6. The method of claim 1, wherein:
classifying the portion comprises classifying the portion as a program segment,
the method further comprises determining that the portion classified as a program segment corresponds to a program specified in an electronic program guide using a timestamp of the portion, and
the data indicating the result of the classifying comprises a data file for the program that includes an indication of the portion.

7. The method of claim 1, wherein:
classifying the portion comprises classifying the portion as an advertisement segment,
the features comprises metadata for the portion, and
the data indicating the result of the classifying comprises a data file that includes the metadata and an indication of the portion.

8. A non-transitory computer-readable medium having stored thereon program instructions that upon execution by a processor, cause performance of a set of acts comprising:
extracting features from media content;
generating repetition data for respective portions of the media content using the features, wherein repetition data for a given portion comprises a list of other portions of the media content matching the given portion;
determining transition data for the media content;
selecting a portion within the media content using the transition data;
classifying the portion as either an advertisement segment or a program segment using repetition data for the portion; and
outputting data indicating a result of the classifying for the portion.

9. The non-transitory computer-readable medium of claim 8, wherein:
extracting the features comprises extracting fingerprints, and
generating the repetition data comprises generating the repetition data using the fingerprints.

10. The non-transitory computer-readable medium of claim 8, wherein:
extracting the features comprises extracting closed captioning, and
generating the repetition data comprises generating the repetition data using the closed captioning.

11. The non-transitory computer-readable medium of claim 8, wherein:
extracting the features comprises extracting keyframes, and
generating the repetition data comprises:
identifying a portion between two adjacent keyframes of the keyframes; and
searching for other portions within the media content having features matching features for the portion.

12. The non-transitory computer-readable medium of claim 8, wherein:
classifying the portion comprises classifying the portion as a program segment,
the set of acts further comprises determining that the portion classified as a program segment corresponds to a program specified in an electronic program guide using a timestamp of the portion, and
the data indicating the result of the classifying comprises a data file for the program that includes an indication of the portion.

13. The non-transitory computer-readable medium of claim 8, wherein:
classifying the portion comprises classifying the portion as an advertisement segment,
the features comprises metadata for the portion, and
the data indicating the result of the classifying comprises a data file that includes the metadata and an indication of the portion.

14. A computing system configured for performing a set of acts comprising:
extracting features from media content;
generating repetition data for respective portions of the media content using the features, wherein repetition data for a given portion comprises a list of other portions of the media content matching the given portion;
determining transition data for the media content;
selecting a portion within the media content using the transition data;
classifying the portion as either an advertisement segment or a program segment using repetition data for the portion; and
outputting data indicating a result of the classifying for the portion.

15. The computing system of claim 14, wherein:
extracting the features comprises extracting fingerprints, and
generating the repetition data comprises generating the repetition data using the fingerprints.

16. The computing system of claim 14, wherein:
extracting the features comprises extracting closed captioning, and
generating the repetition data comprises generating the repetition data using the closed captioning.

17. The computing system of claim 14, wherein:
extracting the features comprises extracting keyframes, and
generating the repetition data comprises:
identifying a portion between two adjacent keyframes of the keyframes; and
searching for other portions within the media content having features matching features for the portion.

18. The computing system of claim 14, wherein:
the transition data comprises predicted transitions between different content segments, and
selecting the portion comprises identifying a portion between two adjacent predicted transitions of the predicted transitions.

19. The computing system of claim 14, wherein:
classifying the portion comprises classifying the portion as a program segment,
the set of acts further comprises determining that the portion classified as a program segment corresponds to a program specified in an electronic program guide using a timestamp of the portion, and
the data indicating the result of the classifying comprises a data file for the program that includes an indication of the portion.

20. The computing system of claim 14, wherein:
classifying the portion comprises classifying the portion as an advertisement segment,
the features comprises metadata for the portion, and
the data indicating the result of the classifying comprises a data file that includes the metadata and an indication of the portion.
